(19) United States
(12) Patent Application Publication
(10) Pub. No.: US 2012/0074363 A1
(43) Pub. Date: Mar. 29, 2012

(54) Hand Puller and a Central Shaft Structure Thereof

(76) Inventor: Wen Cheng Chang, Changhua City (TW)

(21) Appl. No.: 12/891,098

(22) Filed: Sep. 27, 2010

(51) Int. Cl. B25B 25/00

(52) U.S. Cl. 254/218

(57) ABSTRACT

A hand puller and a central shaft structure thereof contains a base including a first and a second sides having a fixed pillar with a fixed rope and a controlling portion with an axial hole respectively, and including a removable retaining member; a pulling member including a first and a second segments having an axial connecting portion with an axial bore and a holding portion individually, and including a movable rod; two ratchets, each including plural teeth and an orifice to match with the central shafts; wherein the retaining member and the movable rod contact with the ratchet respectively, the central shaft is solid, made of a metal bar material, and includes two ends between which an outer surface is defined, and each end of the central shaft includes a limiting member higher than the outer surface so that the base and the ratchets are positioned on the central shafts.

### BACKGROUND OF THE INVENTION

1. Field of the Invention

The present invention relates to a hand puller to bind merchandise on vehicle or stack board, and more particularly to a central shaft structure of a hand puller.

2. Description of the Prior Art

Referring to FIGS. 15 and 16, a conventional hand puller contains a base 60, a pulling member 70 axially connected with the base 60, two ratchets 80 disposed on an axial connection of the base 60 and the pulling member 70, and two central shafts 90 to insert through the base 60, the pulling member 70, and the ratchets 80, wherein the central shafts 90 is solid, made of a metal bar material, and formed in a semi-circular bar shape, a length of the central shaft 90 is longer, and each central shaft 90 includes two circular openings 91 formed on two ends thereof respectively to insert a metal peg 900, thus obtaining a limiting purpose.

However, such a conventional central shaft 90 has the following defects:

1. The two openings 91 are formed on the two ends of the central shaft 90, according the hand puller has to insert the four openings 91 of the two central shafts 90, having a time-consuming manufacture process and high production cost.

2. After two metal pegs 900 are inserted through the central shafts 90, they are further twisted to limit the base 60, the pulling member 70, and the ratchets 80, producing more parts (such as the openings 91 and the metal pegs 900) to increase material cost.

3. The opening 91 is formed in a certain width, and a predetermined length is formed on an outer side of the opening 91, accordingly the central shaft 90 is made in a longer length, increasing material cost.

4. The central shaft 90 has to be made in a heat treatment and electroplate manner, causing higher working cost.

Thereby, the working and material costs of the central shaft 90 are quite expensive.

The present invention has arisen to mitigate and/or obviate the afore-described disadvantages.

### SUMMARY OF THE INVENTION

The primary object of the present invention is to provide a hand puller and a central shaft structure thereof that two ends of a central shafts are press formed to generate the limiting members, therefore the central shaft is capable of made at the shortest length to lower production cost.

Another object of the present invention is to provide a hand puller and a central shaft structure thereof that the central shafts is made at the shortest length to obtain light weight, thus decreasing heat treatment and electroplate costs calculated based on weight.

To obtain the above objectives, a hand puller and a central shaft structure thereof provided by the present invention contains a base, a pulling member, two ratchets, and two central shafts, wherein

the base includes a first side and a second side, the first side includes a fixed pillar with a fixed rope, the second side includes a controlling portion with an axial hole to insert the two central shafts therein;

the pulling member includes a first segment and a second segment, the first segment includes an axial connecting portion with an axial bore, the second segment includes a holding portion, the axial connecting portion of the pulling member matches with the controlling portion of the base, the axial bore is used to insert the two central shafts therein so that the pulling member swings axially relative to the base;

each of the two ratchets includes a plurality of teeth formed around a peripheral side thereof and an orifice disposed on a central portion thereof to match with the central shafts, the ratchet is fixed on the controlling portion of the base and inserted by the central shafts by means of the orifice;

the base includes a removable retaining member mounted therein, the pulling member includes a movable rod, and the retaining member and the movable rod contact with the ratchet respectively;

the central shaft is solid and made of a metal bar material, the central shaft includes two ends between which an outer surface is defined, and each end of the central shaft includes a limiting member formed to be higher than the outer surface so that the base and the ratchets are positioned on the central shafts.

### BRIEF DESCRIPTION OF THE DRAWINGS

FIG. 1 is a perspective view showing the exploded components of a hand puller and a central shaft structure thereof according to a first embodiment of the present invention;

FIG. 2 is a perspective view showing the assembly of the hand puller and the central shaft structure thereof according to the first embodiment of the present invention;

FIG. 3 is a perspective view showing the assembly of a central shaft according to the first embodiment of the present invention;

FIG. 4 is a cross sectional view showing the assembly of the central shaft according to the first embodiment of the present invention;

FIG. 5 is a perspective view showing the assembly of the central shaft according to the first embodiment of the present invention;

FIG. 6 is a cross sectional view with one partial amplified illustration showing the assembly of another central shaft according to another embodiment of the present invention;

FIG. 7 is a cross sectional view showing the operation of the central shaft according to the first embodiment of the present invention;

FIG. 8 is another cross sectional view with two partial amplified illustrations showing the operation of the central shaft according to the first embodiment of the present invention;

FIG. 9 is a cross sectional view with two partial amplified illustrations showing the operation of the another central shaft according to another embodiment of the present invention;

FIG. 10 is another cross sectional view with one partial amplified illustrations showing the operation of the another central shaft according to another embodiment of the present invention;

FIG. 11 is a perspective view showing the assembly of a limiting member of the central shaft according to the first embodiment of the present invention;

FIG. 12 is a perspective view showing the assembly of another limiting member of the central shaft according to the first embodiment of the present invention;

FIG. 13 is a perspective view showing the assembly of another limiting member of the central shaft according to the other embodiment of the present invention;

FIG. 14 is a perspective view showing the assembly of another limiting member of the central shaft according to the other embodiment of the present invention;

FIG. 15 is a perspective view showing the assembly of a conventional hand puller;

FIG. 16 is a cross sectional view showing the assembly of a conventional central shaft.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

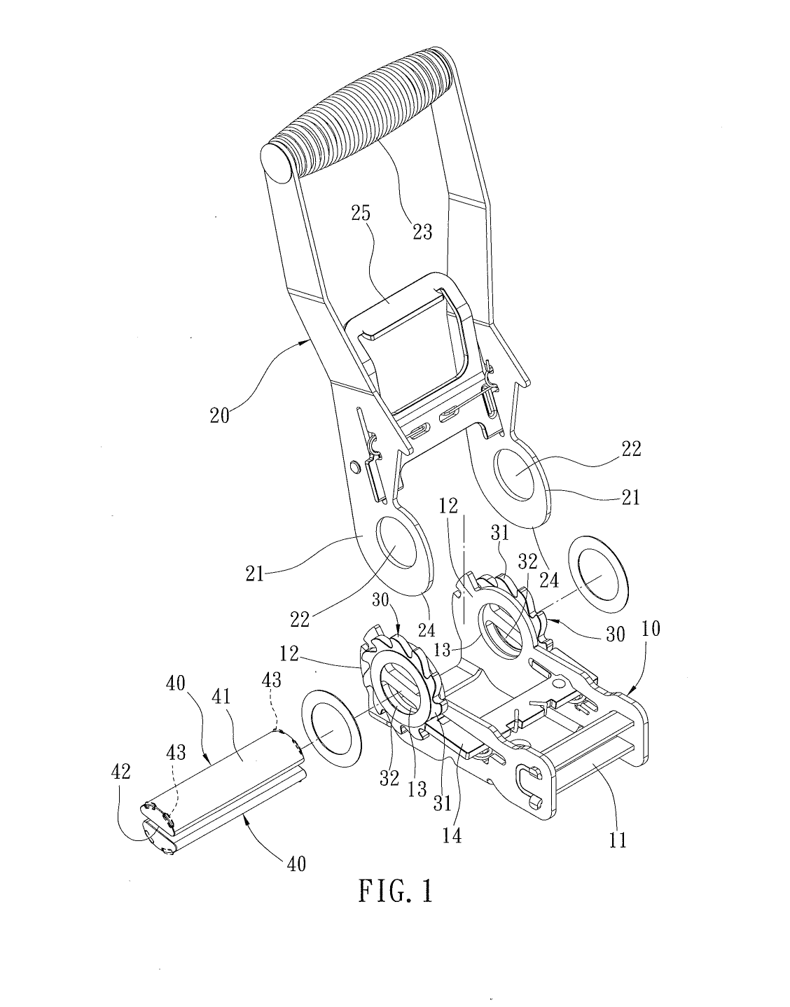

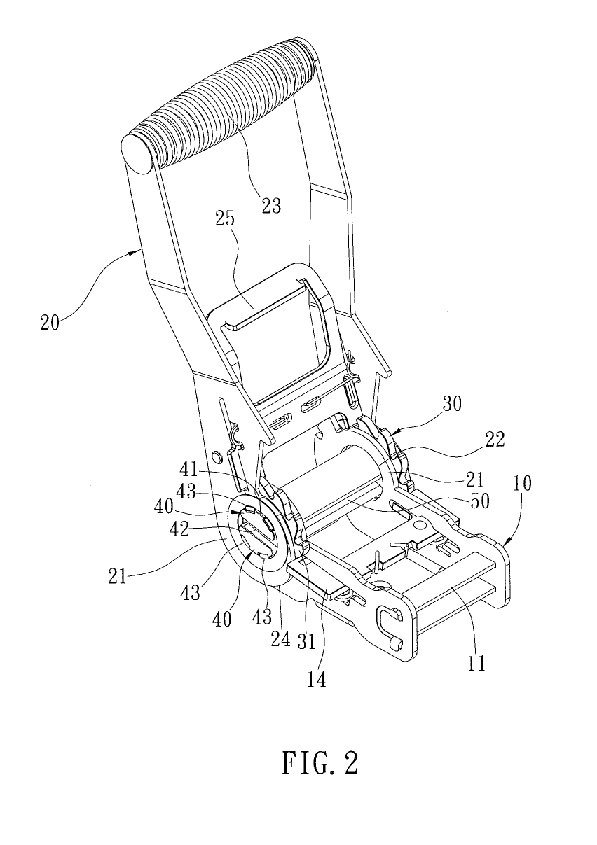

With reference to FIGS. 1-2, a hand puller and a central shaft structure thereof according to a first embodiment of the present invention comprises a base 10, a pulling member 20, two ratchets 30, and two central shafts 40.

The base 10 includes a first side and a second side, the first side includes a fixed pillar 11 with a fixed rope, the second side includes a controlling portion 12 with an axial hole 13, the axial hole 13 is circular to insert the two central shafts 40 therein.

The pulling member 20 includes a first segment and a second segment, the first segment includes an axial connecting portion 21 with an axial bore 22, the second segment includes a holding portion 23 to be held by a user, the axial connecting portion 21 of the pulling member 20 matches with the controlling portion 12 of the base 10, the axial bore 22 is circular to insert the two central shafts 40 therein so that the pulling member 20 swings axially relative to the base 10, and the axial connecting portion 21 includes a projection 24.

Each of the two ratchets 30 includes a plurality of teeth 31 formed around a peripheral side thereof and an orifice 32 disposed on a central portion thereof to match with the central shafts 40, the ratchet 30 is fixed on the controlling portion 12 of the base 10 and inserted by the central shafts 40 by means of the orifice 32.

The base 10 includes a removable retaining member 14 mounted therein, the retaining member 14 abuts against one of the teeth 31 of the ratchet 30, when the base 10 swings axially toward a predetermined angle, the projection 24 of the axial connecting portion 21 of the pulling member 20 is biased against the retaining member 14 so that the retaining member 14 disengages from the ratchet 31. The pulling member 20 includes a movable rod 25 to be pulled by the user, and the movable rod 25 contacts with another one of the teeth 31 of the ratchet 30.

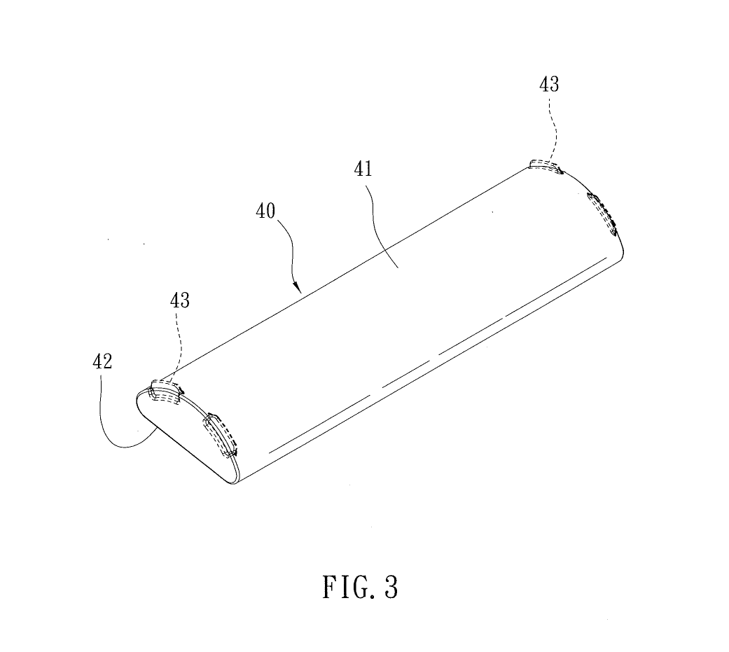

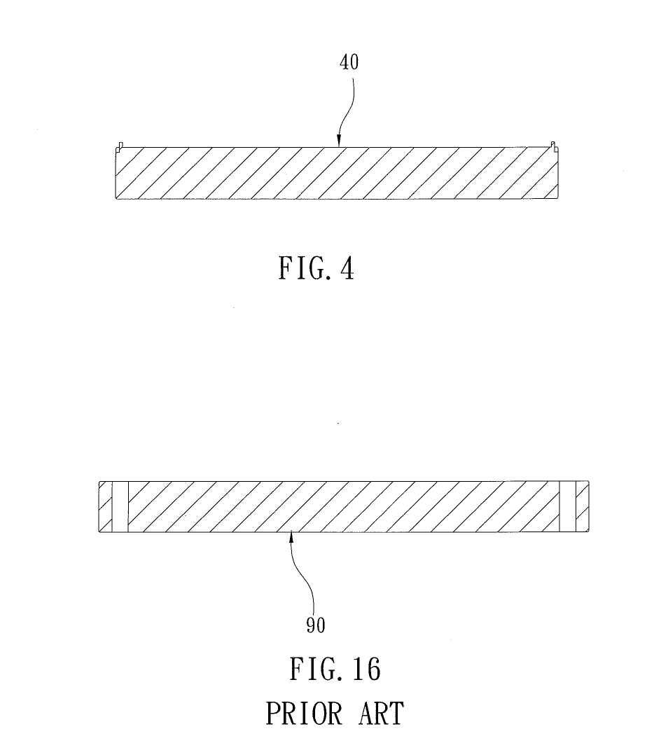

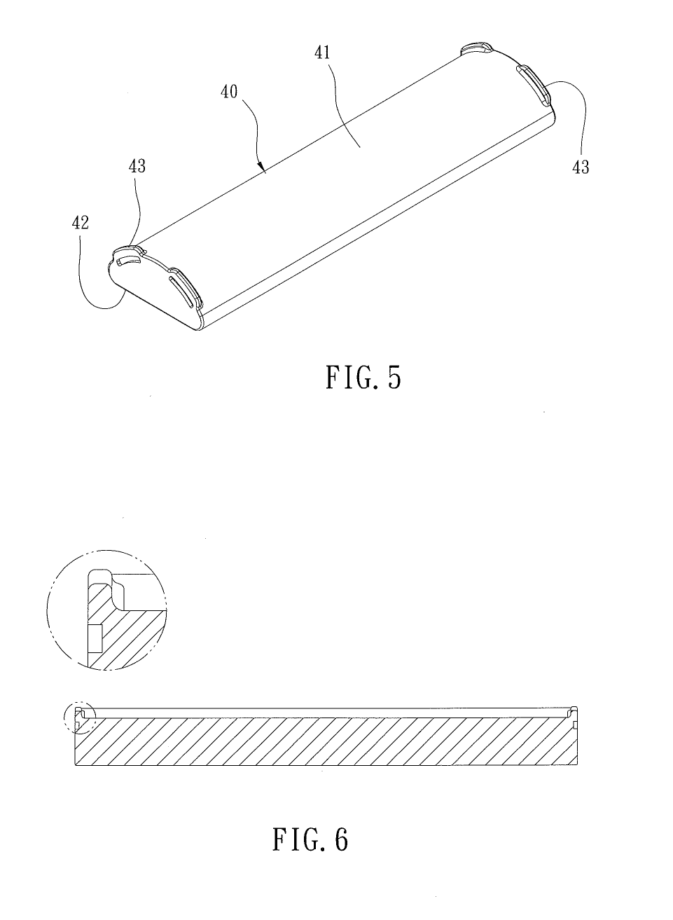

As shown in FIGS. 3-6, the central shaft 40 is solid, made of a metal bar material, and formed in a semi-circular bar shape, when the two central shaft 40 insert into the axial hole 13, between the central shafts 40 is formed a slot 50 to insert one rolled rope, and the central shaft 40 includes two ends between which an outer surface 41 and an inner surface 42 are defined, and each end of the central shaft 40 includes a limiting member 43 formed to be higher than the outer surface 41 so that the base 10, the ratchets 30, and the pulling member 20 are positioned on the central shafts 40.

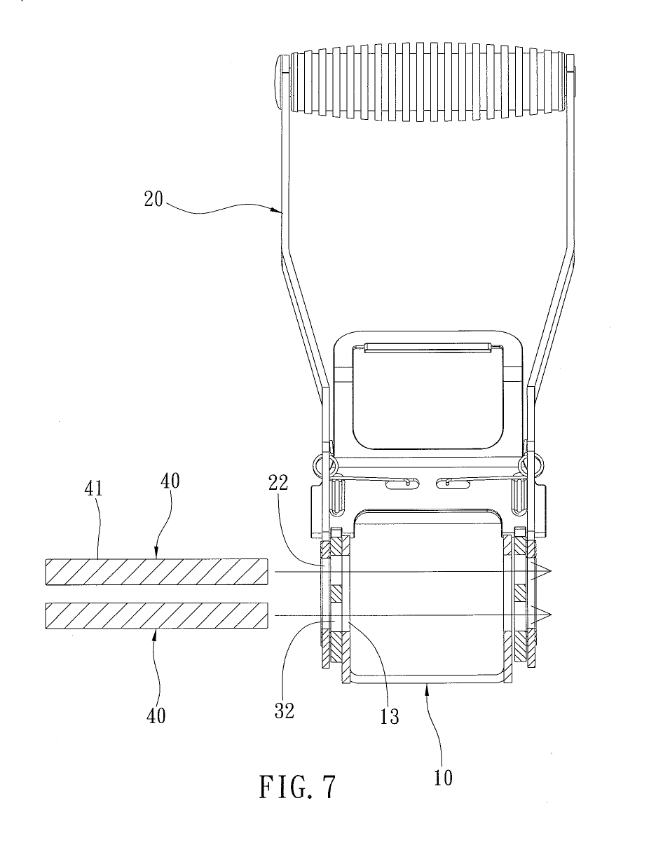

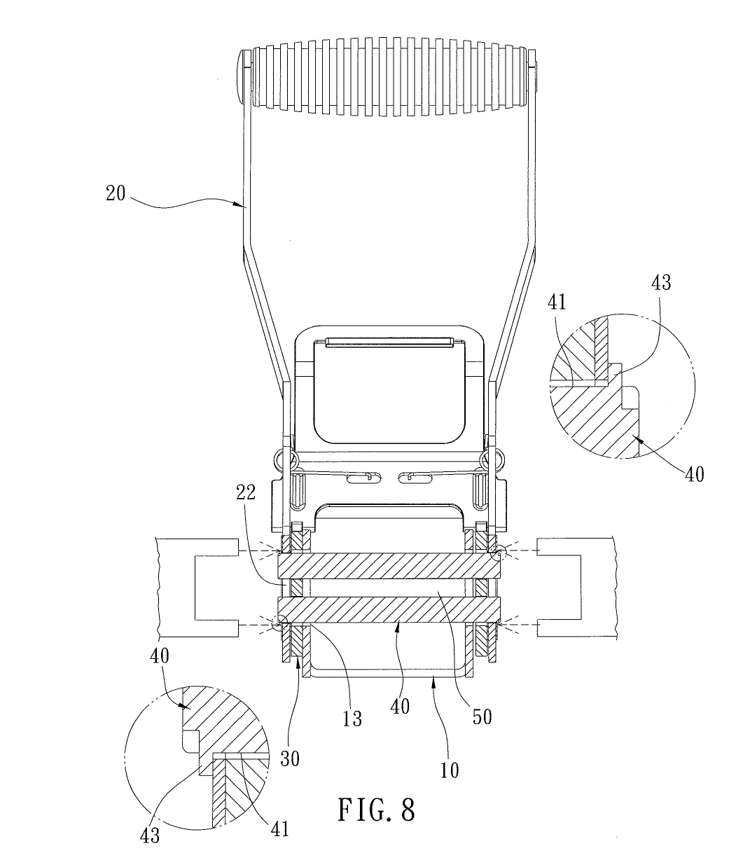

FIGS. 7 and 8 show a method to connect the central shafts 40, wherein the two ends of the central shafts 40 are inserted through the base 10, the ratchets 30, and the pulling member 20 and then are press formed to generate the limiting members 43 higher than the outer surface 41 so that the limiting members 43 of the two ends of the central shafts 40 are used to limit the central shafts 40.

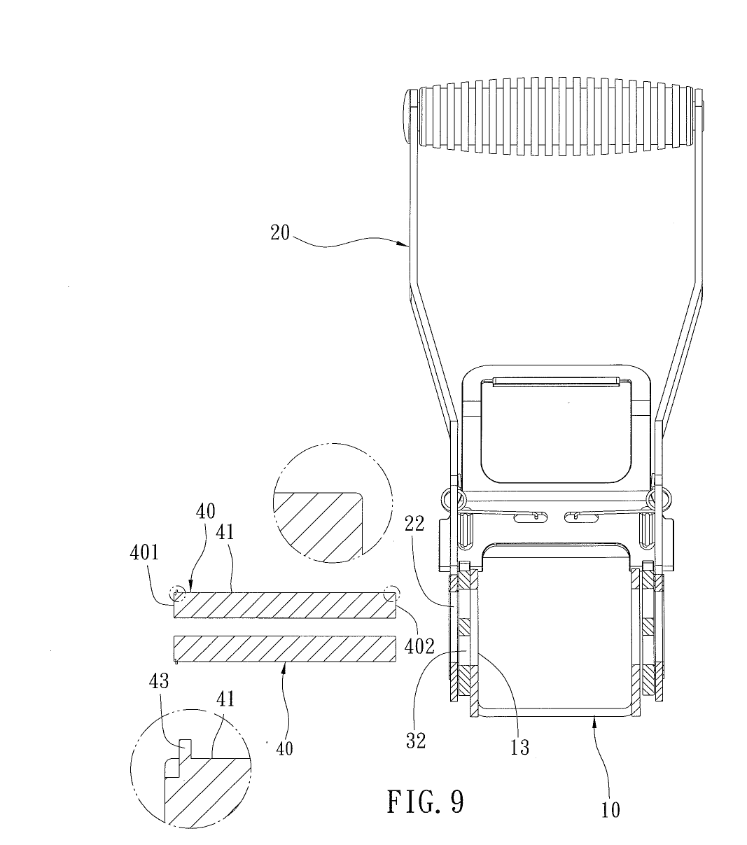

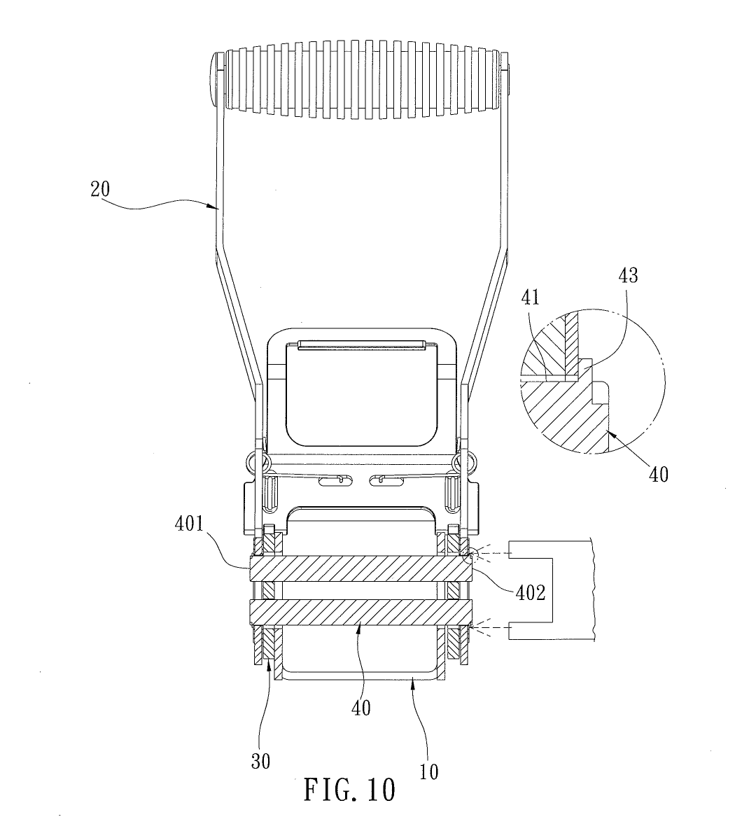

FIGS. 9 and 10 show another method to connect the central shafts 40, wherein a first end 401 of each central shaft 40 includes a limiting member 43 formed to be higher than the outer surface 41, and then a second end 402 of the central shaft 40 is inserted through the base 10, the ratchets 30, and the pulling member 20, after the first end 401 of the central shaft 40 limits the base 10, the ratchets 30, and the pulling member 20 by using the limiting member 43, the second end 402 of the central shaft 40 is press formed to generate another limiting member 43 higher than the outer surface 41, hence the limiting members 43 of the first and the second ends 401, 402 of the central shaft 40 are used to limit the central shaft 40.

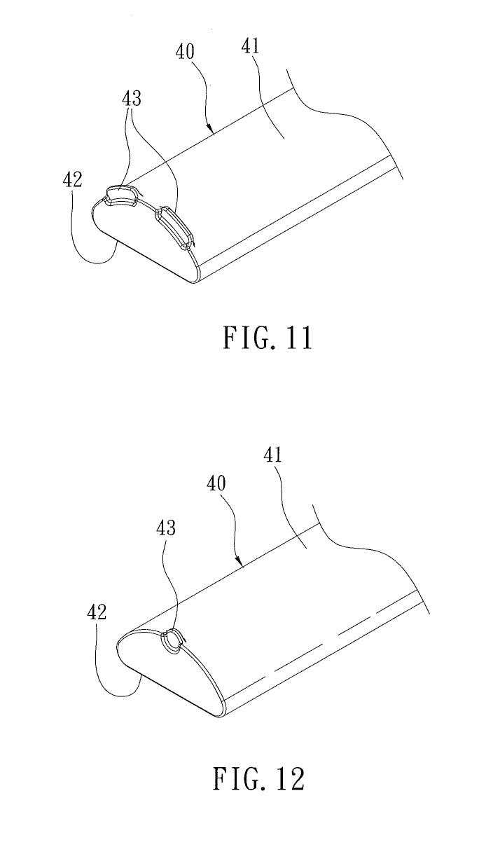

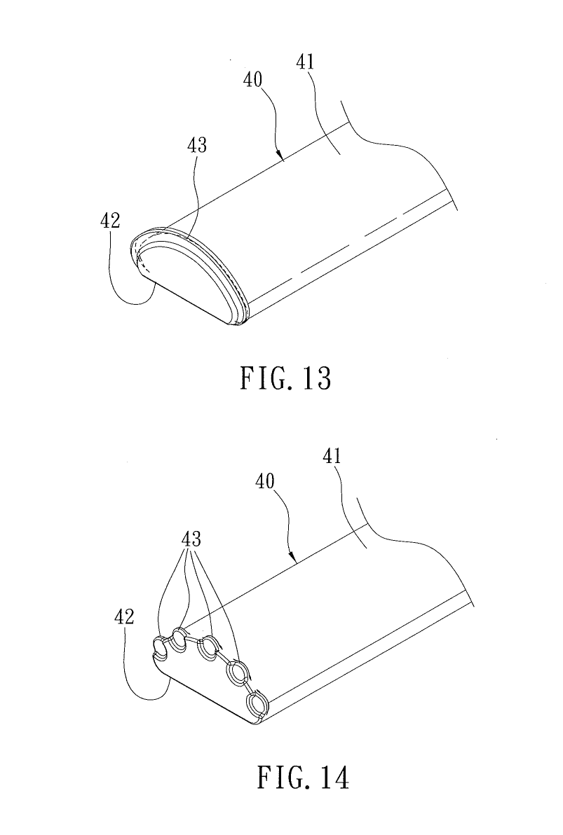

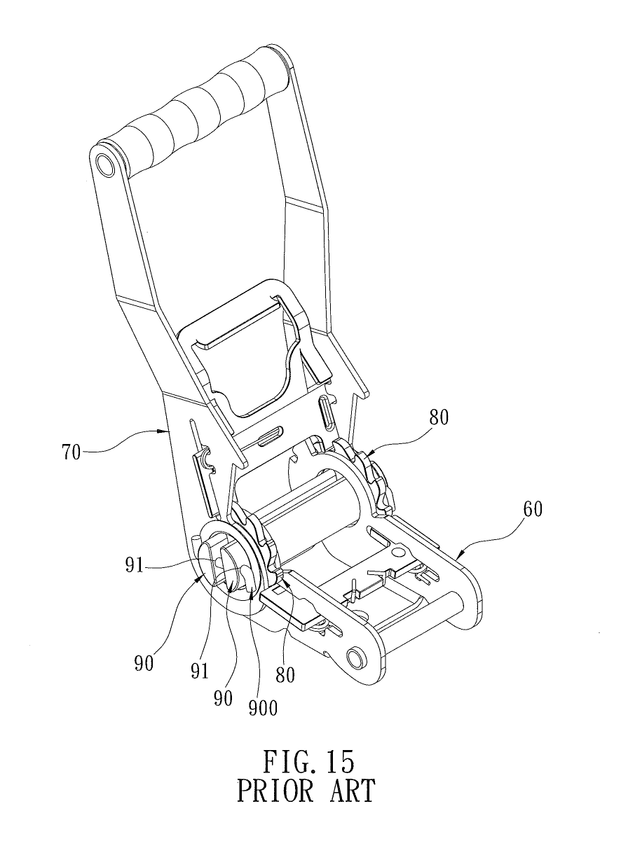

FIG. 11 shows the limiting member 43 is formed in two oval extensions shape. As shown in FIG. 12, the limiting member 43 is formed in a circular projection shape. FIG. 13 shows the limiting member 43 is formed in an arcuate extension shape to correspond to a cross-sectional profile of the outer surface 41. As illustrated in FIG. 14, the limiting member 43 is formed in a plurality of circular projections shape.

While we have shown and described various embodiments in accordance with the present invention, it is clear to those skilled in the art that further embodiments may be made without departing from the scope of the present invention.

What is claimed is:

1. A hand puller comprising: a base, a pulling member, two ratchets, and two central shafts, wherein
the base includes a first side and a second side, the first side includes a fixed pillar with a fixed rope, the second side includes a controlling portion with an axial hole to insert the two central shafts therein;
the pulling member includes a first segment and a second segment, the first segment includes an axial connecting portion with an axial bore, the second segment includes a holding portion, the axial connecting portion of the pulling member matches with the controlling portion of the base, the axial bore is used to insert the two central shafts therein so that the pulling member swings axially relative to the base;
each of the two ratchets includes a plurality of teeth formed around a peripheral side thereof and an orifice disposed on a central portion thereof to match with the central shafts, the ratchet is fixed on the controlling portion of the base and inserted by the central shafts by means of the orifice;
the base includes a removable retaining member mounted therein, the pulling member includes a movable rod, and the retaining member and the movable rod contact with the ratchet respectively;
the central shaft is solid and made of a metal bar material, the central shaft includes two ends between which an outer surface is defined, and each end of the central shaft includes a limiting member formed to be higher than the outer surface so that the base and the ratchets are positioned on the central shafts.

2. The hand puller as claimed in claim 1, wherein the axial hole is circular, the axial bore is circular, the central shaft is formed in a semi-circular bar shape, and between the two central shafts is formed a slot to insert one rolled rope.

3. The hand puller as claimed in claim 1, wherein the axial connecting portion includes a projection, and the retaining member of the base abuts against one of the teeth of the ratchet, when the base swings axially toward a predetermined angle, the projection of the axial connecting portion of the pulling member is biased against the retaining member so that the retaining member disengages from the ratchet, the movable rod of the pulling member is used to be pulled by the user, and the movable rod contacts with another one of the teeth of the ratchet.

4. The hand puller as claimed in claim 1, wherein the limiting members of the two ends of the central shafts are used to limit the base, the ratchets, and the pulling member on the central shafts.

5. The hand puller as claimed in claim 1, wherein the two ends of the central shafts are inserted through the base, the ratchets, and the pulling member and then are press formed to generate the limiting members higher than the outer surface so that the limiting members of the two ends of the central shafts are used to limit the central shafts.

6. The hand puller as claimed in claim 1, wherein a first end of each central shaft includes the limiting member formed to be higher than the outer surface, and then a second end of the central shaft is inserted through the base, the ratchets, and the pulling member, after the first end of the central shaft limits the base, the ratchets, and the pulling member by using the limiting member, the second end of the central shaft is press formed to generate another limiting member higher than the outer surface, hence the limiting members of the first and the second ends of the central shaft are used to limit the central shaft.

7. The hand puller as claimed in claim 1, wherein a shape of the limiting member is selected from two oval extensions, a circular projection, an arcuate extension, and a plurality of circular projections.

8. A central shaft structure of a hand puller including a central shaft, wherein the central shaft is solid, made of a metal bar material, and includes two ends between which an outer surface is defined, and each end of the central shaft includes a limiting member higher than the outer surface, and the limiting member is press formed.

9. The hand puller of the hand puller as claimed in claim 8, wherein the central shaft is formed in a semi-circular bar shape.

10. The hand puller of the hand puller as claimed in claim 8, wherein the hand puller comprises a base, a pulling member, two ratchets, and two central shafts to connect with the base and the pulling member,
the base includes a first side and a second side, the first side includes a fixed pillar with a fixed rope, the second side includes a controlling portion with an axial hole to insert the two central shafts therein;
the pulling member includes a first segment and a second segment, the first segment includes an axial connecting portion with an axial bore, the second segment includes a holding portion, the axial connecting portion of the pulling member matches with the controlling portion of the base, the axial bore is used to insert the two central shafts therein so that the pulling member swings axially relative to the base;
each of the two ratchets includes a plurality of teeth formed around a peripheral side thereof and an orifice disposed on a central portion thereof to match with the central shafts, the ratchet is fixed on the controlling portion of the base and inserted by the central shafts by means of the orifice;
the base includes a removable retaining member mounted therein, the pulling member includes a movable rod, and the retaining member and the movable rod contact with the ratchet respectively;
the central shaft includes two ends, and each end of the central shaft includes a limiting member formed so that the base, the ratchets, and the pulling member are positioned on the central shafts.

11. The hand puller of the hand puller as claimed in claim 10, wherein the two ends of the central shafts are inserted through the base, the ratchets, and the pulling member and then are press formed to generate the limiting members higher than the outer surface so that the limiting members of the two ends of the central shafts are used to limit the central shafts.

12. The hand puller of the hand puller as claimed in claim 10, wherein a first end of each central shaft includes the limiting member formed to be higher than the outer surface, and then a second end of the central shaft is inserted through the base, the ratchets, and the pulling member, after the first end of the central shaft limits the base, the ratchets, and the pulling member by using the limiting member, the second end of the central shaft is press formed to generate another limiting member higher than the outer surface, hence the limiting members of the first and the second ends of the central shaft are used to limit the central shaft.

13. The hand puller as claimed in claim 8, wherein a shape of the limiting member is selected from two oval extensions, a circular projection, an arcuate extension, and a plurality of circular projections.

14. The hand puller as claimed in claim 10, wherein a shape of the limiting member is selected from two oval extensions, a circular projection, an arcuate extension, and a plurality of circular projections.
